(19) United States
(12) Patent Application Publication
(10) Pub. No.: US 2025/0247887 A1
(43) Pub. Date: Jul. 31, 2025

(54) RANDOM ACCESS CHANNEL CONFIGURATION

(71) Applicant: QUALCOMM Incorporated, San Diego, CA (US)

(72) Inventors: Navid ABEDINI, Basking Ridge, NJ (US); Tao LUO, San Diego, CA (US)

(21) Appl. No.: 18/425,856

(22) Filed: Jan. 29, 2024

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive information identifying a set of random access channel (RACH) configurations, wherein a RACH configuration, of the set of RACH configurations, is at least one of: specific to the UE and applicable to a subset of beam directions of a set of beam directions, or specific to a beam. The UE may transmit a RACH message in accordance with the RACH configuration. Numerous other aspects are described.

### FIELD OF THE DISCLOSURE

Aspects of the present disclosure generally relate to wireless communication and specifically relate to techniques, apparatuses, and methods for random access channel configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving information identifying a set of random access channel (RACH) configurations, wherein a RACH configuration, of the set of RACH configurations, is at least one of: specific to the UE and applicable to a subset of beam directions of a set of beam directions, or specific to a beam. The method may include transmitting a RACH message in accordance with the RACH configuration.

Some aspects described herein relate to a method of wireless communication performed by a network node. The method may include transmitting, to a UE, information identifying a set of RACH configurations, wherein a RACH configuration, of the set of RACH configurations, is at least one of: specific to the UE and applicable to a subset of beam directions of a set of beam directions, or specific to a beam. The method may include receiving a RACH message in accordance with the RACH configuration.

Some aspects described herein relate to a UE for wireless communication. The UE may include one or more memories and one or more processors coupled to the one or more memories. The one or more processors may be configured to receive information identifying a set of RACH configurations, wherein a RACH configuration, of the set of RACH configurations, is at least one of: specific to the UE and applicable to a subset of beam directions of a set of beam directions, or specific to a beam. The one or more processors may be configured to transmit a RACH message in accordance with the RACH configuration.

Some aspects described herein relate to a network node for wireless communication. The network node may include one or more memories and one or more processors coupled to the one or more memories. The one or more processors may be configured to transmit, to a UE, information identifying a set of RACH configurations, wherein a RACH configuration, of the set of RACH configurations, is at least one of: specific to the UE and applicable to a subset of beam directions of a set of beam directions, or specific to a beam. The one or more processors may be configured to receive a RACH message in accordance with the RACH configuration.

Some aspects described herein relate to a non-transitory computer-readable medium that stores a set of instructions for wireless communication by an UE. The set of instructions, when executed by one or more processors of the UE, may cause the UE to receive information identifying a set of RACH configurations, wherein a RACH configuration, of the set of RACH configurations, is at least one of: specific to the UE and applicable to a subset of beam directions of a set of beam directions, or specific to a beam. The set of instructions, when executed by one or more processors of the UE, may cause the UE to transmit a RACH message in accordance with the RACH configuration.

Some aspects described herein relate to a non-transitory computer-readable medium that stores a set of instructions for wireless communication by a network node. The set of instructions, when executed by one or more processors of the network node, may cause the network node to transmit, to a UE, information identifying a set of RACH configurations, wherein a RACH configuration, of the set of RACH configurations, is at least one of: specific to the UE and applicable to a subset of beam directions of a set of beam directions, or specific to a beam. The set of instructions, when executed by one or more processors of the network node, may cause the network node to receive a RACH message in accordance with the RACH configuration.

Some aspects described herein relate to an apparatus for wireless communication. The apparatus may include means for receiving information identifying a set of RACH configurations, wherein a RACH configuration, of the set of RACH configurations, is at least one of: specific to the apparatus and applicable to a subset of beam directions of a set of beam directions, or specific to a beam. The apparatus may include means for transmitting a RACH message in accordance with the RACH configuration.

Some aspects described herein relate to an apparatus for wireless communication. The apparatus may include means for transmitting, to a UE, information identifying a set of RACH configurations, wherein a RACH configuration, of the set of RACH configurations, is at least one of: specific to the UE and applicable to a subset of beam directions of a set of beam directions, or specific to a beam. The apparatus may include means for receiving a RACH message in accordance with the RACH configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example disaggregated base station architecture in accordance with the present disclosure.

FIG. 4 is a diagram illustrating an example of a four-step random access channel (RACH) procedure, in accordance with the present disclosure.

FIG. 5 is a diagram illustrating an example of downlink and uplink transmissions between a network node and a UE in a wireless network, in accordance with the present disclosure.

FIG. 6 is a diagram illustrating an example of communicating using a millimeter wave repeater, in accordance with the present disclosure.

FIG. 7 is a diagram illustrating an example associated with a timing offset for RACH preamble transmission, in accordance with the present disclosure.

FIG. 8 is a diagram illustrating an example associated with RACH configuration, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may use a random access channel (RACH) procedure to obtain access to one or more communication services from a network node. For example, in a RACH procedure, the UE and the network node may exchange one or more sets of messages to provide the UE with timing information and select a beam that the UE is to use for communication with the network node. In this case, the UE detects a downlink timing from a synchronization signal block (SSB) transmission and transmits an initial RACH message as an uplink transmission using the downlink timing (e.g., without a timing advance (TA) for uplink timing).

The network node may be configured to monitor for a range of round-trip times (RTTs) that can accommodate differing timings for receiving the initial RACH message, which is transmitted using the downlink timing. UEs at a cell center may transmit initial RACH messages with relatively small RTT values and UEs at a cell edge may transmit initial RACH messages with relatively large RTT values, resulting in a relatively large range of RTT values that the network node is to accommodate. A preamble format (e.g., a cyclic prefix (CP) and guard period (GP) length) and a cyclic shift are configured to accommodate a largest possible RTT value that the network node accommodates.

However, in some scenarios, the network node may be configured to accommodate different ranges of maximum RTT values. For example, when a cell coverage is expanded using a repeater, the repeater may introduce additional delay to an RTT as a result of an internal delay associated with receiving and repeating a transmission. The cell may include one or more repeaters for one or more beam directions, resulting in non-uniform coverage and non-uniform maximum RTT values. In other words, the cell may have a relatively small maximum RTT value for some beam directions in which there are no repeaters configured and a relatively large maximum RTT value for other beam directions in which a plurality of repeaters may be configured.

In some configurations, the network node may configure monitoring for RACH messages to accommodate a largest maximum RTT value that is possible across all possible beam directions. For example, the network node may identify a beam direction with a largest possible maximum RTT value (e.g., a beam direction with one or more repeaters), and may configure a monitoring period using the identified largest possible maximum RTT value on a plurality of beam directions (e.g., on some beam directions for which the maximum RTT value is smaller than the largest possible maximum RTT value). However, configuring a monitoring period on some beam directions using the identified largest possible maximum RTT value may result in excessive monitoring for beam directions for which the maximum RTT value is smaller than the identified largest possible maximum RTT value.

In some configurations, the network node may configure a beam-specific RACH configuration. In this case, each beam direction may have a monitoring period configured based on a respective maximum RTT value, rather than the largest possible maximum RTT value being used for all beam directions. However, in a single beam direction, a network node may be associated with groups of UEs that have different possible maximum RTT values. For example, the network node may be associated with a first group of UEs that does not use a repeater and has a first maximum RTT value and a second group of UEs that uses a repeater and has a second maximum RTT value that is larger than the first RTT value. Accordingly, configuring an RTT value based on the second maximum RTT value for the second group of UEs may result in excessive monitoring for the first group of UEs. Similarly, configuring other RACH configuration parameters on a beam-common or beam-specific basis may result in inefficient energy usage or spectral usage for some UEs.

Various aspects relate generally to RACH configuration. Some aspects more specifically relate to a beam-specific TA offset that is configured to accommodate an RTT on a subset of access links. In some aspects, the network node may configure a beam-specific TA offset that is applied when a UE is transmitting in an initial RACH message in one or more configured RACH occasions (ROs). Additionally, or alternatively, the network node may configure a plurality of TA offsets for a set of beams and the UE may use a particular TA offset, of the plurality of TA offsets, that is associated with one or more communication parameters. Some aspects more specifically relate to beam and/or user-specific RACH configuration. In some aspects, a network node may configure user-specific RACH configurations for a subset of a set of possible beam directions. For example, the network node may transmit, to a UE, signaling identifying RACH configurations for beam directions in which a user-specific RACH occasion (RO) is configured.

Particular aspects of the subject matter described in this disclosure can be implemented to realize one or more of the following potential advantages. In some examples, by configuring a beam-specific TA offset (or a set of TA offsets), the network node and the UE may account for fixed RTT delays associated with repeaters or non-ground-based UEs. This may enable the network node and the UE to use spectral and energy resources more efficiently than occurs when an excessively large monitoring period is configured to account for large maximum possible RTT values. In some examples, by configuring a beam and/or user specific RACH configuration, different types of UEs or use cases for UEs may use RACH configurations that efficiently utilize energy or spectral resources.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

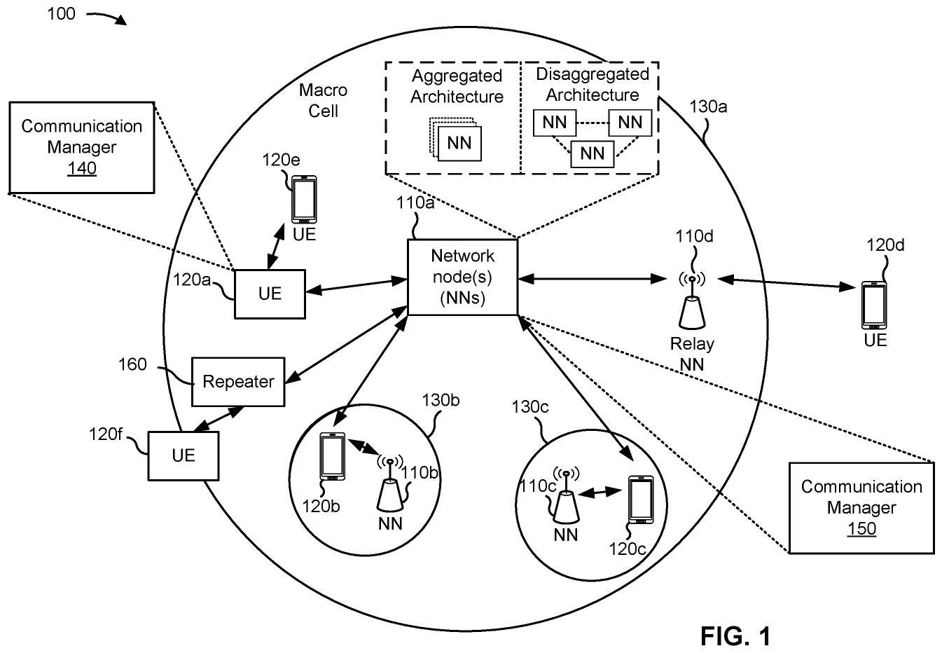

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive information identifying a set of RACH configurations, wherein a RACH configuration, of the set of RACH configurations, is at least one of: specific to the UE and applicable to a subset of beam directions of a set of beam directions, or specific to a beam; and transmit a RACH message in accordance with the RACH configuration. Additionally, or alternatively, the communication manager 140 may perform one or more other operations described herein.

In some aspects, the network node 110 may include a communication manager 150. As described in more detail elsewhere herein, the communication manager 150 may transmit, to a UE, information identifying a set of RACH configurations, wherein a RACH configuration, of the set of RACH configurations, is at least one of: specific to the UE and applicable to a subset of beam directions of a set of beam directions, or specific to a beam; and receive a RACH message in accordance with the RACH configuration. Additionally, or alternatively, the communication manager 150 may perform one or more other operations described herein.

In some examples, a millimeter wave (mmW) repeater 160 may receive a millimeter wave signal (e.g., an analog millimeter wave signal) from a network node 110, may amplify the millimeter wave signal, and may transmit the amplified millimeter wave signal to one or more UEs 120 (e.g., shown as UE 120f). In some examples, the mmW repeater 160 may be an analog mmW repeater, sometimes also referred to as a layer 1 mmW repeater. Additionally, or alternatively, the mmW repeater 160 may be a wireless transmit receive point (TRP) acting as a distributed unit (e.g., of a 5G access node) that communicates wirelessly with a network node 110 acting as a central unit or an access node controller (e.g., of the 5G access node). The mmW repeater may receive, amplify, and transmit the analog mmW signal without performing analog-to-digital conversion of the analog mmW signal and/or without performing any digital signal processing on the mmW signal. In this way, latency may be reduced and a cost to produce the mmW repeater 160 may be reduced.

As indicated above, FIG. 1 is provided as an example. Other examples may differ from what is described with regard to FIG. 1.

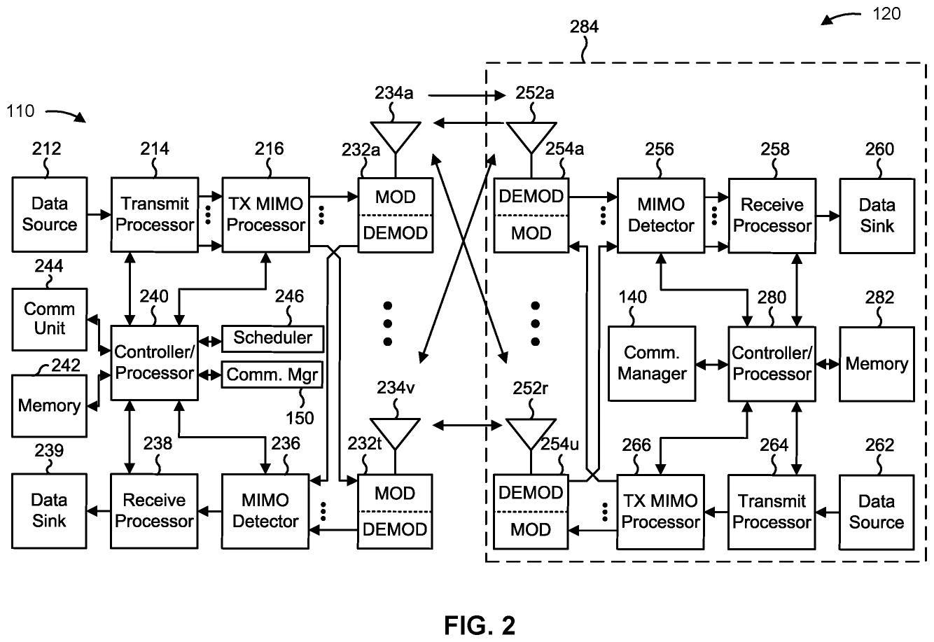

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, the UE 120 includes means for receiving information identifying a set of RACH configurations, wherein a RACH configuration, of the set of RACH configurations, is at least one of: specific to the UE and applicable to a subset of beam directions of a set of beam directions, or specific to a beam; and/or means for transmitting a RACH message in accordance with the RACH configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, information identifying a set of RACH configurations, wherein a RACH configuration, of the set of RACH configurations, is at least one of: specific to the UE and applicable to a subset of beam directions of a set of beam directions, or specific to a beam; and/or means for receiving a RACH message in accordance with the RACH configuration. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 2 is provided as an example. Other examples may differ from what is described with regard to FIG. 2.

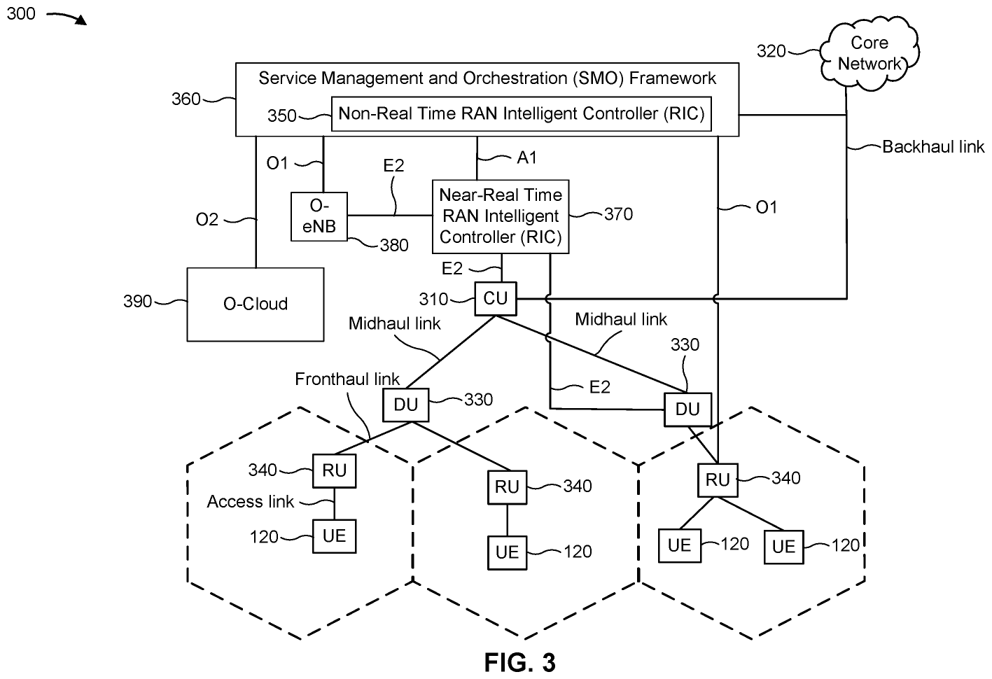

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the El interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an Al interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

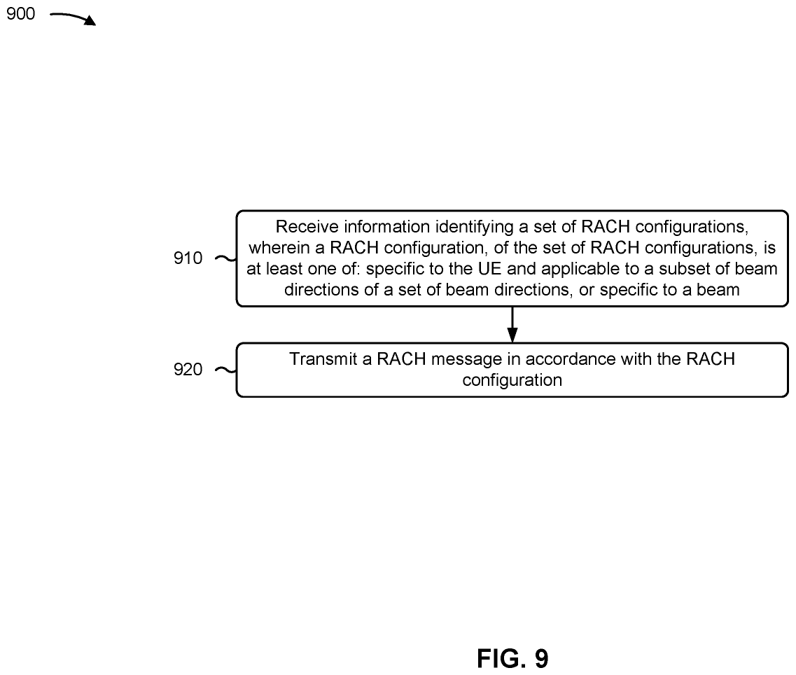

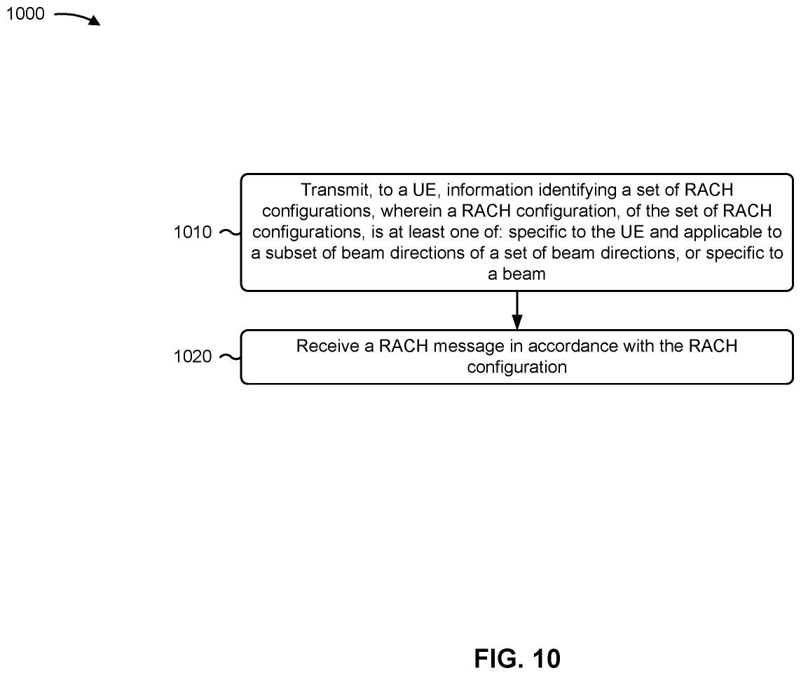

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with random access channel configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

As indicated above, FIG. 3 is provided as an example. Other examples may differ from what is described with regard to FIG. 3.

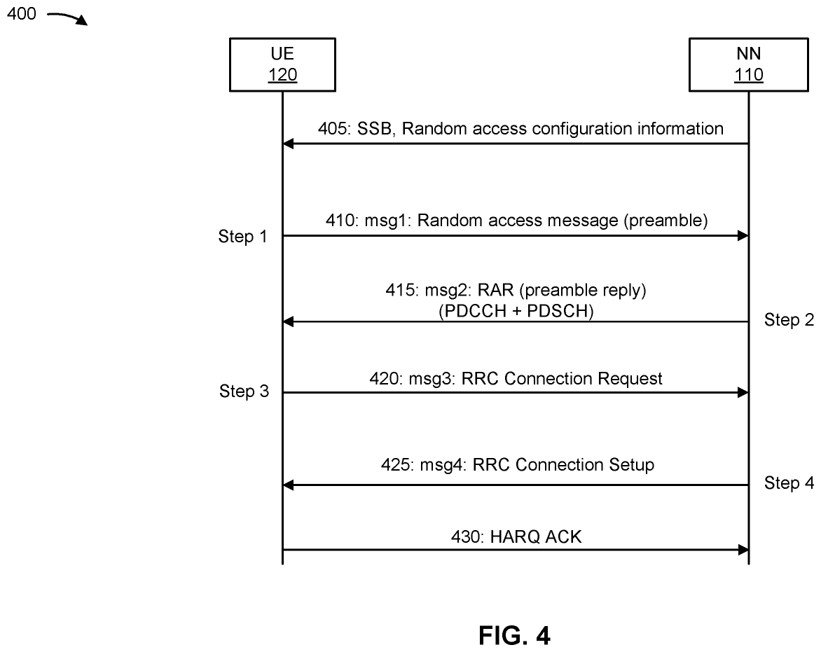

FIG. 4 is a diagram illustrating an example of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a medium access control (MAC) protocol data unit (PDU) of the PDSCH communication.

As shown by reference number 420, the UE 120 may transmit a radio resource control (RRC) connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgment (ACK).

As indicated above, FIG. 4 is provided as an example. Other examples may differ from what is described with regard to FIG. 4.

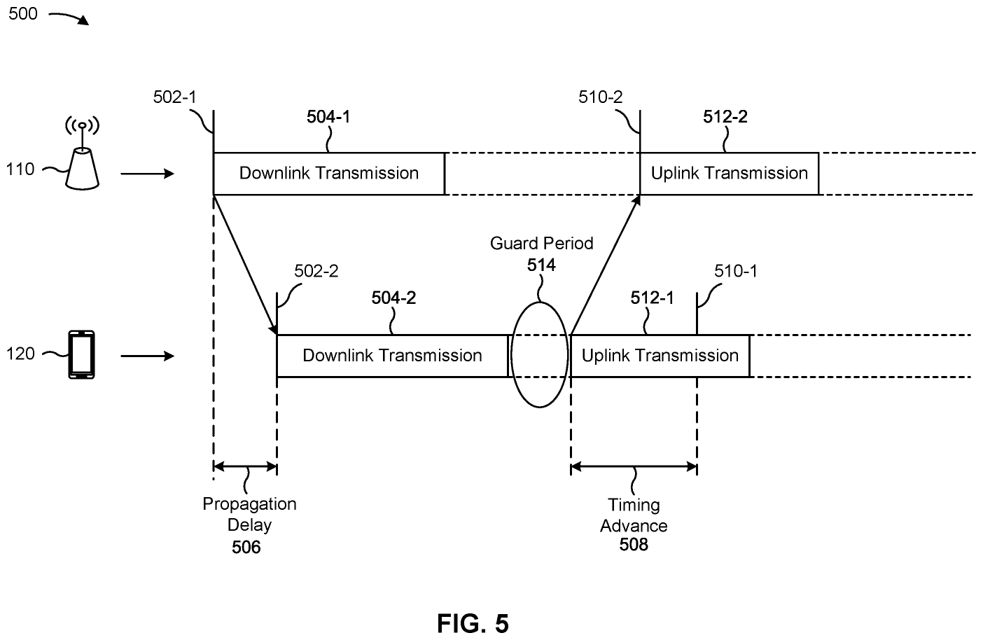

FIG. 5 is a diagram illustrating an example 500 of downlink and uplink transmissions between a network node 110 and a UE 120 in a wireless network 100, in accordance with the present disclosure. In some examples, the downlink and/or uplink transmissions are based at least in part on a timing advance and/or a guard period between communications. As one example, a network node 110 may configure a downlink transmission to end before the start of a guard period. As another example, the UE 120 may advance a start time for an uplink transmission based at least in part on a timing advance.

As shown by reference number 502-1, a network node 110 may begin a downlink transmission 504-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (ms)). Each radio frame may be further partitioned into a set of Z (Z≥1) subframes, where each subframe may have a predetermined duration (e.g., 1 ms). Each subframe may be further partitioned into a set of slots and/or each slot may include a set of L symbol periods (e.g., fourteen symbol periods, seven symbol periods, or another number of symbol periods). Thus, the first point in time as shown by the reference number 502-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 502-1, the network node 110 may begin the downlink transmission 504-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 506 in time, such as a time delay based at least in part on the downlink transmission traveling between a network node 110 (e.g., an RU) and the UE 120. As shown by reference number 502-2, the UE 120 may receive downlink transmission 504-2 (corresponding to downlink transmission 504-1 transmitted by the network node 110) at a second point in time that is later in time relative to the first point in time. From a time perspective of the UE 120, however, the UE 120 may associate the second point in physical time shown by the reference number 502-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 500, the time perspective of the UE 120 may be delayed in time from the time perspective of the network node 110.

In wireless communication technologies like 4G/LTE and 5G/NR, a timing advance (TA) value is used to control a timing of uplink transmissions by a UE (e.g., UE 120 and/or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 510-1, a start of the scheduled point in time may occur at a third physical point in time based at least in part on the timing perspective of the UE 120. However, and as shown by reference number 510-2, the scheduled point in time with reference to the timing perspective of the network node 110 (e.g., an RU) may occur at a fourth point in physical time that occurs before the third point in physical time as shown by the reference number 510-1. Accordingly, the network node 110 may instruct the UE 120 (e.g., directly or via one or more network nodes) to apply a timing advance 508 to an uplink transmission to better align reception of the uplink transmission with the timing perspective of the network node 110. However, in some examples, the fourth point in time shown by the reference number 510-2 may occur at or near a same physical point in time as the third point in time shown by the reference number 510-1 such that uplink transmissions from the UE 120 to the network node 110 incur the propagation delay 506. In such a scenario, the network node 110 may instruct the UE 120 to apply a timing advance with a time duration corresponding to the propagation delay 506.

As shown by the example 500, the UE 120 may adjust a start time of an uplink transmission 512-1 based at least in part on the timing advance 508 and the start of the scheduled point in time (e.g., at the third physical point in time shown by the reference number 510-1). Based at least in part on propagation delay, the network node 110 may receive an uplink transmission 512-2 (corresponding to the uplink transmission 512-1 transmitted by the UE 120) at the fourth point in physical time shown by the reference number 510-2.

In some examples, a timing advance value may be based at least in part on twice an estimated propagation delay (e.g., the propagation delay 506) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 514 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 514 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 504-1 based at least in part on beginning the transmission at the first point in time shown by the reference number 502-1 and/or the UE 120 completing reception of the downlink transmission 504-2 prior to a starting point of the guard period 514. Alternatively, or additionally, the UE 120 may select an amount of content (e.g., data and/or control information) to transmit in the uplink transmission 512-1 based at least in part on the timing advance 508, the third point in time shown by the reference number 510-1, and/or refraining from beginning the uplink transmission 512-1 until the guard period 514 has ended.

As indicated above, FIG. 5 is provided as an example. Other examples may differ from what is described with regard to FIG. 5.

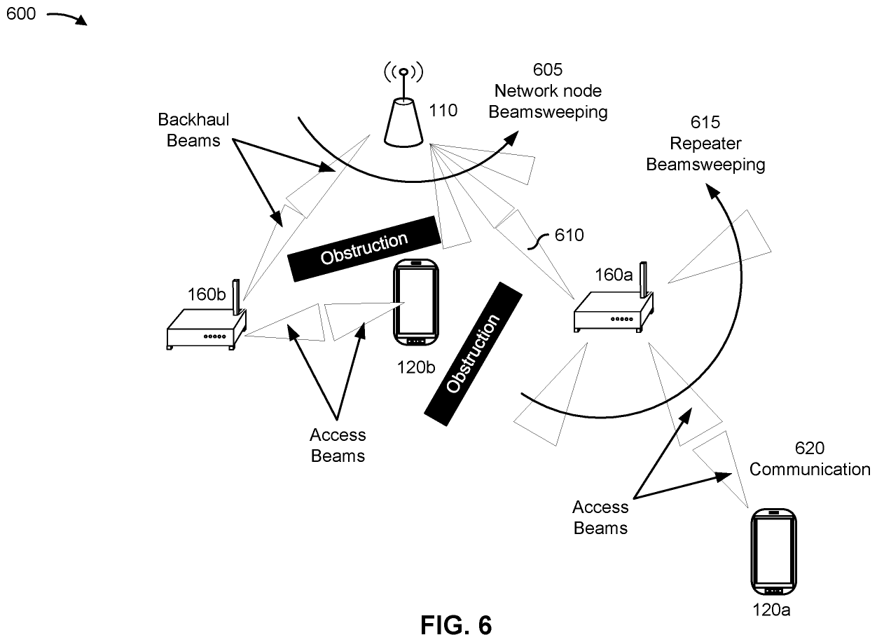

FIG. 6 is a diagram illustrating an example 600 of communicating using a millimeter wave repeater, in accordance with the present disclosure.

Because millimeter wave communications have a higher frequency and shorter wavelength than other types of radio waves used for communications (e.g., sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110 that communicates using the sub-6 GHz radio waves. However, a millimeter wave may not be capable of penetrating the same wall (e.g., depending on a thickness of the wall and/or a material from which the wall is constructed). Some techniques and apparatuses described herein use a millimeter wave repeater 160 (which includes, in the example of FIG. 6, repeater 160a and repeater 160b) to increase the coverage area of a network node 110 and/or to extend coverage to UEs 120 (which include, in the example of FIG. 6, UE 120a and UE 120b) without line of sight to the network node 110 (e.g., due to an obstruction).

For example, as illustrated in the example of FIG. 6, an obstruction between UE 120b and network node 110 blocks or otherwise reduces the quality of a link between the network node 110 and UE 120b. Similarly, an obstruction between UE 120b and repeater 160a blocks or otherwise reduces the quality of a link between the repeater 160a and the UE 120b. However, no obstructions or fewer obstructions exist between repeater 160b and UE 120b, and, as such, it is possible that communications between repeater 160b and UE 120b will have a higher quality than communications between network node 110 and UE 120b or between repeater 160a and UE 120b. Furthermore, the millimeter wave repeater 160 described herein may be a layer 1 or an analog millimeter wave repeater, which is associated with a lower cost, less processing, and lower latency than a layer 2 or layer 3 repeater.

A millimeter wave repeater 160 (sometimes referred to herein as a repeater 160) may perform directional communication by using beamforming to communicate with a network node 110 via a first beam pair (e.g., a backhaul beam pair over a backhaul link with the network node 110) and to communicate with a UE 120 via a second beam pair (e.g., an access beam pair over an access link with the UE 120). For example, in example 600, repeater 160a can communicate with network node 110 via a first beam pair and can communicate with UE 120a via a second beam pair. Similarly, repeater 160b can communicate with network node 110 via a first beam pair and can communicate with UE 120a via a second beam pair. A beam pair may refer to a transmit (Tx) beam used by a first device for transmission and a receive (Rx) beam used by a second device for reception of information transmitted by the first device via the Tx beam.

As shown by reference number 605, a network node 110 may use a beamsweeping procedure to transmit communications via multiple beams over time (e.g., using time division multiplexing (TDM)). As shown by reference number 610, the repeater 160a may receive a communication via an Rx beam of the repeater 160a. As shown by reference number 615, the repeater 160a may relay each received communication via multiple Tx beams of the repeater 160a (e.g., using TDM). As used herein, relaying a communication may refer to transmitting the received communication (e.g., after amplifying the received communication) without decoding the received communication and/or without modifying information carried in the received communication. Alternatively, relaying a received communication may refer to transmitting the received communication after decoding the received communication and/or modifying information carried in the received communication. In some examples, a received communication may be relayed using a different time resource, a different frequency resource, and/or a different spatial resource (e.g., a different beam) to transmit the communication as compared to a time resource, a frequency resource, and/or a spatial resource in which the communication was received. As shown by reference number 620, a UE 120a may receive a relayed communication. In some examples, the UE 120a may generate a communication to be transmitted to the network node 110. The UE 120a may then transmit the communication to the repeater 160a for relaying to the network node 110.

As indicated above, FIG. 6 is provided as an example. Other examples may differ from what is described with regard to FIG. 6.

A network node may be configured to monitor for a range of RTTs that can accommodate differing timings for receiving an initial RACH message, which is transmitted using a downlink timing. UEs at a cell center may transmit initial RACH messages with relatively small RTT values and UEs at a cell edge may transmit initial RACH messages with relatively large RTT values, resulting in a relatively large range of RTT values that the network node is to accommodate. A preamble format (e.g., a cyclic prefix (CP) and guard period (GP) length) and a cyclic shift are configured to accommodate a largest possible RTT value that the network node accommodates.

However, in some scenarios, the network node may be configured to accommodate different ranges of maximum RTT values. For example, when a cell coverage is expanded using a repeater, the repeater may introduce additional delay to an RTT as a result of an internal delay associated with receiving and repeating a transmission. The cell may include one or more repeaters for one or more beam directions, resulting in non-uniform coverage and non-uniform maximum RTT values. In other words, the cell may have a relatively small maximum RTT value for some beam directions in which there are no repeaters configured and a relatively large maximum RTT value for other beam directions in which a plurality of repeaters may be configured.

In some configurations, the network node may configure monitoring for RACH messages to accommodate a largest maximum RTT value that is possible across all possible beam directions. For example, the network node may identify a beam direction with a largest possible maximum RTT value (e.g., a beam direction with one or more repeaters), and may configure a monitoring period using the identified largest possible maximum RTT value on a plurality of beam directions (e.g., on some beam directions for which the maximum RTT value is smaller than the largest possible maximum RTT value). However, configuring a monitoring period on some beam directions using the identified largest possible maximum RTT value may result in excessive monitoring for beam directions for which the maximum RTT value is smaller than the identified largest possible maximum RTT value.

In some configurations, the network node may configure a beam-specific RACH configuration. In this case, each beam direction may have a monitoring period configured based on a respective maximum RTT value, rather than the largest possible maximum RTT value being used for all beam directions. However, in a single beam direction, a network node may be associated with groups of UEs that have different possible maximum RTT values. For example, the network node may be associated with a first group of UEs that does not use a repeater and has a first maximum RTT value and a second group of UEs that uses a repeater and has a second maximum RTT value that is larger than the first RTT value. Accordingly, configuring an RTT value based on the second maximum RTT value for the second group of UEs may result in excessive monitoring for the first group of UEs. Similarly, configuring other RACH configuration parameters on a beam-common or beam-specific basis may result in inefficient energy usage or spectral usage for some UEs.

Various aspects relate generally to RACH configuration. Some aspects more specifically relate to a beam-specific TA offset that is configured to accommodate an RTT on a subset of access links. In some aspects, the network node may configure a beam-specific TA offset that is applied when a UE is transmitting in an initial RACH message in one or more configured RACH occasions (ROs). Additionally, or alternatively, the network node may configure a plurality of TA offsets for a set of beams and the UE may use a particular TA offset, of the plurality of TA offsets, that is associated with one or more communication parameters. Some aspects more specifically relate to beam and/or user-specific RACH configuration. In some aspects, a network node may configure user-specific RACH configurations for a subset of a set of possible beam directions. For example, the network node may transmit, to a UE, signaling identifying RACH configurations for beam directions in which a user-specific RACH occasion (RO) is configured.

Particular aspects of the subject matter described in this disclosure can be implemented to realize one or more of the following potential advantages. In some examples, by configuring a beam-specific TA offset (or a set of TA offsets), the network node and UE may account for fixed RTT delays associated with repeaters or non-ground-based UEs. This may enable the network node and the UE to use spectral and energy resources more efficiently than occurs when an excessively large monitoring period is configured to account for large maximum possible RTT values. In some examples, by configuring a beam and/or user specific RACH configuration, different types of UEs or use cases for UEs may use RACH configurations that efficiently utilize energy or spectral resources.

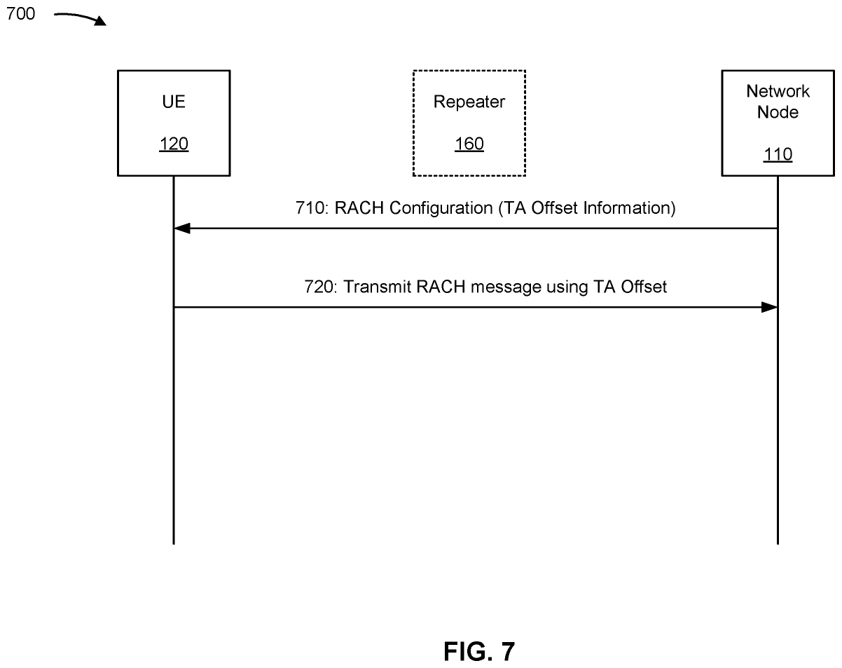

FIG. 7 is a diagram illustrating an example 700 associated with a timing offset for RACH preamble transmission, in accordance with the present disclosure. As shown in FIG. 7, example 700 includes communication between a network node 110 and a UE 120. In some aspects, the network node 110 and the UE 120 may communicate via repeater 160. For example, the network node 110 may operate in a cell that includes one or more repeaters to extend a coverage area of the network node 110 and may communicate with some UEs 120 in the cell directly and other UEs 120 in the cell indirectly (e.g., via one or more repeaters 160). In some aspects, the network node 110 may communicate in a cell without repeaters, but that includes one or more characteristics associated with relatively large RTTs. For example, the network node 110 may communicate with one or more non-ground-based UEs 120, such as one or more UEs that are being operated in an aerial vehicle (e.g., an airplane or another type of aerial vehicle).

As further shown in FIG. 7, and by reference number 710, the UE 120 may receive RACH configuration information. For example, the UE 120 may receive information including a set of RACH configurations, which may include TA offset information identifying one or more TA offsets for the UE 120 to use in transmitting a RACH message. In some aspects, the UE 120 may receive information identifying a beam-specific TA offset. For example, the network node 110 may configure a TA offset for a particular beam and may transmit RACH configuration information to identify the TA offset to the UE 120, which may use the TA offset when transmitting a RACH message in an RO associated with the particular beam.

In some aspects, the UE 120 may receive information identifying a plurality of TA offsets. For example, the UE 120 may receive information identifying a plurality of values for a TA offset (e.g., with a zero or null value indicating no TA offset and a non-zero or non-null value indicating an amount of TA offset). In this case, the plurality of values for the TA offset may correspond to a plurality of beams and associated ROs that the UE 120 may use for transmitting a RACH message. In other words, the network node 110 may configure one or more beam-specific TA offsets for a set of beams that are used for initial RACH message transmission. In some aspects, the network node 110 may determine the plurality of TA offsets based at least in part on receiving backhauling signaling. For example, the network node 110 may receive or transmit backhauling signaling from, or to, one or more other network nodes to determine a set of possible TA offsets to provide to the UE 120 for selection. In some aspects, the network node 110 may indicate one or more TA offsets, to the UE 120, using a particular type of signaling. For example, the network node 110 may include information identifying a plurality of possible TA offsets in a synchronization signal block (SSB) transmission. In some aspects, the network node 110 and/or the UE 120 may use a device learning and suggesting procedure to identify and/or select a TA offset.

In some aspects, the UE 120 may select, for transmitting an initial RACH message, a TA offset, from a plurality of possible TA offsets, based at least in part on one or more parameters. For example, the UE 120 may select a TA offset associated with a type or class of the UE 120. In this case, the UE 120 may select a first TA offset when the UE 120 is a first type of UE and a second TA offset when the UE 120 is a second type of UE. As examples, types of UEs may include reduced capability (RedCap) UEs, fixed wireless access (FWA) UEs, customer premises equipment (CPE) UEs, non-ground-based UEs, integrated access and backhauling (IAB) mobile terminals (MTs), wireless RUs, network control repeater (NCR) MTs, or other types of UEs. In this case, different types of UEs may be associated with different delay characteristics and the network node 110 may configure the plurality of possible TA offsets to account for the different delay characteristics. For example, non-ground-based UEs may have a greater distance from the network node 110 than other UEs, and NCR MTs may have different processing delays than other UEs.

Additionally, or alternatively, the UE 120 may select a TA offset based at least in part on a distance parameter. For example, the UE 120 or the network node 110 may determine an estimated distance between the UE 120 and the network node 110 (e.g., based on location information, ranging information, signal strength, or another parameter) and may select a TA offset selected for use with the estimated distance. Additionally, or alternatively, the UE 120 may select the TA offset based at least in part on a reference signal received power (RSRP), a pathloss (PL) amount, or a difference in downlink reception timing from different cells. In this case, the network node 110 may configure the plurality of TA offsets to cover different ranges of distances, and the UE 120 may select a TA offset corresponding to a determination relating to a distance of the UE 120 from the network node 110.

Additionally, or alternatively, the UE 120 may select a TA offset based at least in part on an explicit indication. For example, the UE 120 may receive an explicit indication from a serving cell that the UE 120 was connected to before a RACH procedure to select a TA offset for the RACH procedure. Additionally, or alternatively, the UE 120 may receive a broadcast or unicast signal from a neighboring cell indicating a TA offset to use for transmitting a RACH message to a cell.

Additionally, or alternatively, the UE 120 may select a TA offset based at least in part on a coverage zone. For example, the network node 110 may indicate a set of coverage zones corresponding to possible locations of a UE 120 or measurements from one or more neighboring cells. In this case, when the UE 120 performs the measurements of the one or more neighboring cells, the UE 120 may identify a coverage zone of the UE 120 and select a TA offset corresponding to the identified coverage zone. Additionally, or alternatively, the UE 120 may select a TA offset based at least in part on an output of an artificial intelligence or machine learning (AI/ML) model. For example, the network node 110 may transmit one or more model parameters to the UE 120, which the UE 120 may use to execute the AI/ML model and select a TA offset. In this case, the one or more model parameters may relate to a measurement history or a set of locations, among other examples.

Additionally, or alternatively, the UE 120 may select a TA offset based at least in part on a type of network node 110 from which the UE 120 receives a signal. For example, when the UE 120 receives a synchronization signal block (SSB) signal from an assisting network node (e.g., a repeater 160 or a reconfigurable intelligent surface (RIS)), the UE 120 may select a TA offset indicated to be applicable to indirect communications. In contrast, when the UE 120 receives the SSB signal from the network node 110 directly, the UE 120 may select a TA offset indicated to be applicable to direct communications. In these cases, the UE 120 may determine whether the SSB signal is received directly or indirectly based at least in part on an SSB watermark (e.g., which may be applied by the repeater 160), an SSB frequency shift (e.g., which may be generated by an NCR), or another technique.

Additionally, or alternatively, the UE 120 may select a TA offset based at least in part on a result of a sensing procedure performed by the UE 120. For example, the UE 120 may monitor one or more signals being transmitted in a cell to determine one or more sensed parameters relating to uplink transmission in the cell. In this case, the UE 120 may select a TA offset associated with an approximation of an uplink timing determined using the sensing procedure.

As further shown in FIG. 7, and by reference number 720, the UE 120 may transmit a RACH message using the TA offset. For example, the UE 120 may use a TA offset indicated in the RACH configuration information for transmitting an initial RACH message, such as a RACH message A of a two-step RACH procedure, or a RACH message 1 of a four-step RACH procedure. Additionally, or alternatively, the UE 120 may use a selected TA offset, of a plurality of possible TA offsets indicated in the RACH configuration information, for transmitting the initial RACH message. For example, the UE 120 may select a TA offset based at least in part on a type of the UE, a location of the UE, an explicit indication, a coverage zone, an output of an AI/ML module, a source of the SSB signaling, or an output of a sensing procedure. Based at least in part on the UE 120 transmitting the RACH message, the UE 120 and the network node 110 may perform a RACH procedure to provide the UE 120 with access to network services.

As indicated above, FIG. 7 is provided as an example. Other examples may differ from what is described with respect to FIG. 7.

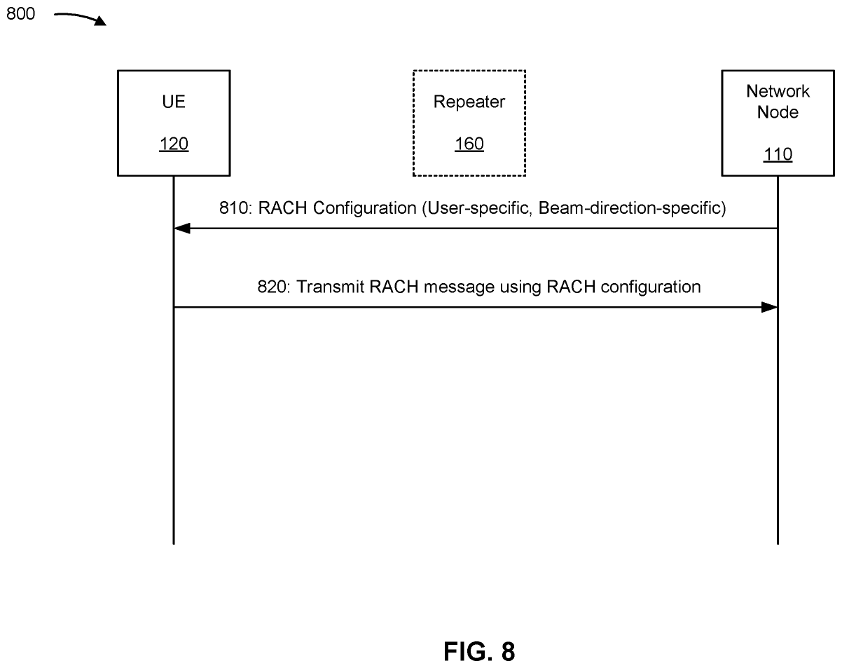

FIG. 8 is a diagram illustrating an example 800 associated with RACH configuration, in accordance with the present disclosure. As shown in FIG. 8, example 800 includes communication between a network node 110 and a UE 120. In some aspects, the network node 110 and the UE 120 may communicate via a repeater 160. For example, the network node 110 may operate in a cell that includes one or more repeaters to extend a coverage area of the network node 110, and may communicate with some UEs 120 in the cell directly and other UEs 120 in the cell indirectly (e.g., via one or more repeaters 160). In some aspects, the network node 110 may communicate in a cell that has no repeaters, but that includes one or more characteristics associated with relatively large RTTs. For example, the network node 110 may communicate with one or more non-ground-based UEs 120, such as one or more UEs that are being operated in an aerial vehicle (e.g., an airplane or another type of aerial vehicle).

As further shown in FIG. 8, and by reference number 810, the UE 120 may receive RACH configuration information. For example, the UE 120 may receive, from the network node 110, information identifying a user-specific RACH configuration and/or a beam-direction-specific RACH configuration. In some aspects, a RACH configuration, such as a user-specific RACH configuration and/or a beam-direction-specific RACH configuration, may include one or more RACH parameters. For example, the RACH configuration may include information identifying a TA offset, an uplink timing, a preamble format, a guard band format, a cyclic prefix format, a cyclic shift format, or another parameter associated with a RACH procedure and/or one or more messages thereof. In this case, the network node 110 may transmit information identifying a RACH configuration that is applicable to a particular UE 120 (e.g., a user-specific RACH configuration) and/or maps to one or more beam directions (and associated RACH occasions) (e.g., a beam-direction-specific RACH configuration). For example, the network node 110 may configure a first type of RACH configuration that is applicable to a first type of UE (e.g., an IAB MT UE) and a second type of RACH configuration that is applicable to a second type of UE (e.g., a non-IAB MT UE).

In some aspects, the UE 120 may receive RACH configuration information via a particular type of message. For example, the UE 120 may receive, from the network node 110, system information (SI) or radio resource control (RRC) signaling identifying one or more RACH configurations. In some aspects, the one or more RACH configurations may be applicable to a subset of a set of possible beam directions. For example, the UE 120 may receive an indication of one or more beam directions to which a RACH configuration, of the one or more RACH configurations, is applicable. In some aspects, the indication of the one or more beam directions may include a bitmap. For example, the network node 110 may transmit, in the SI or RRC signaling, a bitmap with each bit corresponding to a beam direction. In this case, a bit value of “0” may indicate that an associated RACH configuration is not applicable to a particular beam direction and a bit value of “1” may indicate that an associated RACH configuration is applicable to the particular beam direction. Additionally, or alternatively, the network node 110 may transmit an indication of a value, which the UE 120 may use to identify a set of beam directions (e.g., in a lookup table) to which a RACH configuration is applicable.

In some aspects, the UE 120 may receive information associated with updating a mapping of RACH configurations to beams or beam directions. For example, the network node 110 may alter a set of beams for which a RACH configuration is active based at least in part on a mobility of one or more network nodes, a load-balancing criterion, or an energy saving criterion. In this case, rather than transmit a system information change or system information update indication to a plurality of UEs, the network node 110 may transmit an indication of an updated bitmap (e.g., identifying beam direction applicability) via a type of short message. For example, the network node 110 may transmit a physical downlink control channel (PDCCH) or physical downlink shared channel (PDSCH) conveying an updated bitmap. In this case, the PDCCH or PDSCH short message may have a reduced size or be transmitted to a reduced quantity of devices relative to a system information update indication, thereby reducing a utilization of network resources to update a beam direction.

In some aspects, the UE 120 may request a particular mapping of RACH configurations to beams or beam directions. For example, the UE 120 may transmit a request for a beam-specific activation or deactivation of a user-specific RACH occasion. In this case, the network node 110 may transmit a response message confirming (or rejecting) the request for the beam-specific activation or deactivation of the user-specific RACH occasion. For example, the network node 110 may transmit a response message with an updated bitmap that confirms a new mapping of a RACH configuration to a beam direction as requested by the UE 120. In some aspects, the network node 110 may receive the request from the UE 120, from a network interface, or via an application programming interface (API).

As further shown in FIG. 8, and by reference number 820, the UE 120 may transmit a RACH message using a RACH configuration, such as a user-specific RACH configuration and/or a beam-direction-specific RACH configuration. For example, the UE 120 may identify a beam direction for transmitting a RACH message (e.g., an initial RACH message), identify a RACH occasion associated with the beam direction, and use a RACH configuration associated with the beam direction for transmitting in the identified RACH occasion. In this case, the UE 120 may transmit using a preamble format (e.g., a cyclic prefix or a guard band) or a cyclic shift identified in the RACH configuration.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with RACH configuration.

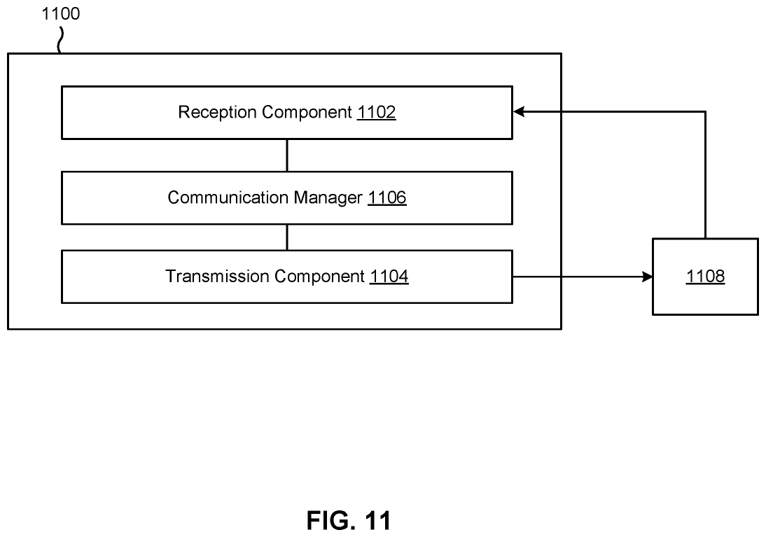

As shown in FIG. 9, in some aspects, process 900 may include receiving information identifying a set of RACH configurations, wherein a RACH configuration, of the set of RACH configurations, is at least one of: specific to the UE and applicable to a subset of beam directions of a set of beam directions, or specific to a beam (block 910). For example, the UE (e.g., using reception component 1102 and/or communication manager 1106, depicted in FIG. 11) may receive information identifying a set of RACH configurations, wherein a RACH configuration, of the set of RACH configurations, is at least one of: specific to the UE and applicable to a subset of beam directions of a set of beam directions, or specific to a beam, as described above.

As further shown in FIG. 9, in some aspects, process 900 may include transmitting a RACH message in accordance with the RACH configuration (block 920). For example, the UE (e.g., using transmission component 1104 and/or communication manager 1106, depicted in FIG. 11) may transmit a RACH message in accordance with the RACH configuration, as described above.

Process 900 may include additional aspects, such as any single aspect or any combination of aspects described below and/or in connection with one or more other processes described elsewhere herein.

In a first aspect, the RACH configuration includes a beam-specific timing advance offset for the RACH message.

In a second aspect, alone or in combination with the first aspect, the set of RACH configurations includes information identifying a plurality of timing advance offsets configured for a set of beams.

In a third aspect, alone or in combination with one or more of the first and second aspects, the RACH message is transmitted with a timing advance offset, of the plurality of timing advance offsets, in connection with a parameter, wherein the parameter is at least one of a type of the UE, a distance metric associated with the UE, a channel metric associated with the UE, a received indication, a coverage zone parameter, a result of executing a machine learning model, a synchronization signal block source, or a result of executing a sensing procedure.

In a fourth aspect, alone or in combination with one or more of the first through third aspects, receiving the information identifying the set of RACH configurations comprises receiving the information identifying the set of RACH configurations based at least in part on backhaul signaling associated with establishing the set of RACH configurations.

In a fifth aspect, alone or in combination with one or more of the first through fourth aspects, the set of RACH configurations is received via a broadcast signal or a dedicated signal.

In a sixth aspect, alone or in combination with one or more of the first through fifth aspects, process 900 includes transmitting an indication of one or more RACH configurations, and receiving the information identifying the set of RACH configurations comprises receiving the information identifying the set of RACH configurations as a response to transmitting the indication of the one or more RACH configurations.

In a seventh aspect, alone or in combination with one or more of the first through sixth aspects, the information identifying the set of RACH configurations is received via a system information or radio resource control message.

In an eighth aspect, alone or in combination with one or more of the first through seventh aspects, the information identifying the set of RACH configurations includes one or more bitmaps indicating one or more SSB directions to which one or more user-specific RACH occasions are applicable.

In a ninth aspect, alone or in combination with one or more of the first through eighth aspects, process 900 includes receiving a system information message including a bitmap identifying a change to a set of beams with an active RACH configuration associated with the set of RACH configurations, and transmitting the RACH message in accordance with the set of RACH configurations comprises transmitting the RACH message in accordance with the bitmap.

In a tenth aspect, alone or in combination with one or more of the first through ninth aspects, process 900 includes transmitting a request for a change to a set of UE-specific RACH occasions, and receiving the system information message comprises receiving the system information message as a response to transmitting the request for the change.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with RACH configuration.

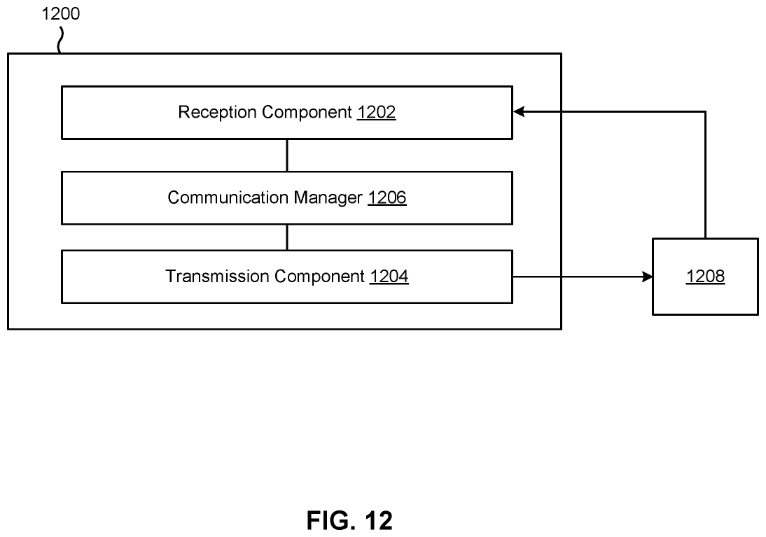

As shown in FIG. 10, in some aspects, process 1000 may include transmitting, to a UE, information identifying a set of RACH configurations, wherein a RACH configuration, of the set of RACH configurations, is at least one of: specific to the UE and applicable to a subset of beam directions of a set of beam directions, or specific to a beam (block 1010). For example, the network node (e.g., using transmission component 1204 and/or communication manager 1206, depicted in FIG. 12) may transmit, to a UE, information identifying a set of RACH configurations, wherein a RACH configuration, of the set of RACH configurations, is at least one of: specific to the UE and applicable to a subset of beam directions of a set of beam directions, or specific to a beam, as described above.

As further shown in FIG. 10, in some aspects, process 1000 may include receiving a RACH message in accordance with the RACH configuration (block 1020). For example, the network node (e.g., using reception component 1202 and/or communication manager 1206, depicted in FIG. 12) may receive a RACH message in accordance with the RACH configuration, as described above.

Process 1000 may include additional aspects, such as any single aspect or any combination of aspects described below and/or in connection with one or more other processes described elsewhere herein.

In a first aspect, the RACH configuration includes a beam-specific timing advance offset for the RACH message.

In a second aspect, alone or in combination with the first aspect, the set of RACH configurations includes information identifying a plurality of timing advance offsets configured for a set of beams.

In a third aspect, alone or in combination with one or more of the first and second aspects, the RACH message is transmitted with a timing advance offset, of the plurality of timing advance offsets, in connection with a parameter, wherein the parameter is at least one of a type of the UE, a distance metric associated with the UE, a channel metric associated with the UE, a received indication, a coverage zone parameter, a result of executing a machine learning model, a synchronization signal block source, or a result of executing a sensing procedure.

In a fourth aspect, alone or in combination with one or more of the first through third aspects, transmitting the information identifying the set of RACH configurations comprises transmitting the information identifying the set of RACH configurations based at least in part on backhaul signaling associated with establishing the set of RACH configurations.

In a fifth aspect, alone or in combination with one or more of the first through fourth aspects, the set of RACH configurations is received via a broadcast signal or a dedicated signal.

In a sixth aspect, alone or in combination with one or more of the first through fifth aspects, process 1000 includes receiving an indication of one or more RACH configurations, and transmitting the information identifying the set of RACH configurations comprises transmitting the information identifying the set of RACH configurations as a response to receiving the indication of the one or more RACH configurations.

In a seventh aspect, alone or in combination with one or more of the first through sixth aspects, the information identifying the set of RACH configurations is received via a system information or radio resource control message.

In an eighth aspect, alone or in combination with one or more of the first through seventh aspects, the information identifying the set of RACH configurations includes one or more bitmaps indicating one or more SSB directions to which one or more user-specific RACH occasions are applicable.

In a ninth aspect, alone or in combination with one or more of the first through eighth aspects, process 1000 includes transmitting a system information message including a bitmap identifying a change to a set of beams with an active RACH configuration associated with the set of RACH configurations, and receiving the RACH message in accordance with the set of RACH configurations comprises receiving the RACH message in accordance with the bitmap.

In a tenth aspect, alone or in combination with one or more of the first through ninth aspects, process 1000 includes receiving a request for a change to a set of UE-specific RACH occasions, and transmitting the system information message comprises transmitting the system information message as a response to receiving the request for the change.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive information identifying a set of RACH configurations, wherein a RACH configuration, of the set of RACH configurations, is at least one of: specific to the apparatus 1100 and applicable to a subset of beam directions of a set of beam directions, or specific to a beam. The transmission component 1104 may transmit a RACH message in accordance with the RACH configuration.

The transmission component 1104 may transmit an indication of one or more RACH configurations. The reception component 1102 may receive a system information message including a bitmap identifying a change to a set of beams with an active RACH configuration associated with the set of RACH configurations. The transmission component 1104 may transmit a request for a change to a set of apparatus-specific RACH occasions.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, information identifying a set of RACH configurations, wherein a RACH configuration, of the set of RACH configurations, is at least one of: specific to the UE and applicable to a subset of beam directions of a set of beam directions, or specific to a beam. The reception component 1202 may receive a RACH message in accordance with the RACH configuration.

The reception component 1202 may receive an indication of one or more RACH configurations. The transmission component 1204 may transmit a system information message including a bitmap identifying a change to a set of beams with an active RACH configuration associated with the set of RACH configurations. The reception component 1202 may receive a request for a change to a set of UE-specific RACH occasions.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving information identifying a set of random access channel (RACH) configurations, wherein a RACH configuration, of the set of RACH configurations, is at least one of: specific to the UE and applicable to a subset of beam directions of a set of beam directions, or specific to a beam; and transmitting a RACH message in accordance with the RACH configuration.

Aspect 2: The method of Aspect 1, wherein the RACH configuration includes a beam-specific timing advance offset for the RACH message.

Aspect 3: The method of any of Aspects 1-2, wherein the set of RACH configurations includes information identifying a plurality of timing advance offsets configured for a set of beams.

Aspect 4: The method of Aspect 3, wherein the RACH message is transmitted with a timing advance offset, of the plurality of timing advance offsets, in connection with a parameter, wherein the parameter is at least one of: a type of the UE, a distance metric associated with the UE, a channel metric associated with the UE, a received indication, a coverage zone parameter, a result of executing a machine learning model, a synchronization signal block source, or a result of executing a sensing procedure.

Aspect 5: The method of any of Aspects 1-4, wherein receiving the information identifying the set of RACH configurations comprises: receiving the information identifying the set of RACH configurations based at least in part on backhaul signaling associated with establishing the set of RACH configurations.

Aspect 6: The method of any of Aspects 1-5, wherein the set of RACH configurations is received via a broadcast signal or a dedicated signal.

Aspect 7: The method of any of Aspects 1-6, further comprising: transmitting an indication of one or more RACH configurations; and wherein receiving the information identifying the set of RACH configurations comprises: receiving the information identifying the set of RACH configurations as a response to transmitting the indication of the one or more RACH configurations.

Aspect 8: The method of any of Aspects 1-7, wherein the information identifying the set of RACH configurations is received via a system information or radio resource control message.

Aspect 9: The method of any of Aspects 1-8, wherein the information identifying the set of RACH configurations includes one or more bitmaps indicating one or more synchronization signal block (SSB) directions to which one or more user-specific RACH occasions are applicable.

Aspect 10: The method of any of Aspects 1-9, further comprising: receiving a system information message including a bitmap identifying a change to a set of beams with an active RACH configuration associated with the set of RACH configurations, and wherein transmitting the RACH message in accordance with the set of RACH configurations comprises: transmitting the RACH message in accordance with the bitmap.

Aspect 11: The method of Aspect 10, further comprising: transmitting a request for a change to a set of UE-specific RACH occasions; and wherein receiving the system information message comprises: receiving the system information message as a response to transmitting the request for the change.

Aspect 12: A method of wireless communication performed by a network node, comprising: transmitting, to a user equipment (UE), information identifying a set of random access channel (RACH) configurations, wherein a RACH configuration, of the set of RACH configurations, is at least one of: specific to the UE and applicable to a subset of beam directions of a set of beam directions, or specific to a beam; and receiving a RACH message in accordance with the RACH configuration.

Aspect 13: The method of Aspect 12, wherein the RACH configuration includes a beam-specific timing advance offset for the RACH message.

Aspect 14: The method of any of Aspects 12-13, wherein the set of RACH configurations includes information identifying a plurality of timing advance offsets configured for a set of beams.

Aspect 15: The method of Aspect 14, wherein the RACH message is transmitted with a timing advance offset, of the plurality of timing advance offsets, in connection with a parameter, wherein the parameter is at least one of: a type of the UE, a distance metric associated with the UE, a channel metric associated with the UE, a received indication, a coverage zone parameter, a result of executing a machine learning model, a synchronization signal block source, or a result of executing a sensing procedure.

Aspect 16: The method of any of Aspects 12-15, wherein transmitting the information identifying the set of RACH configurations comprises: transmitting the information identifying the set of RACH configurations based at least in part on backhaul signaling associated with establishing the set of RACH configurations.

Aspect 17: The method of any of Aspects 12-16, wherein the set of RACH configurations is received via a broadcast signal or a dedicated signal.

Aspect 18: The method of any of Aspects 12-17, further comprising: receiving an indication of one or more RACH configurations; and wherein transmitting the information identifying the set of RACH configurations comprises: transmitting the information identifying the set of RACH configurations as a response to receiving the indication of the one or more RACH configurations.

Aspect 19: The method of any of Aspects 12-18, wherein the information identifying the set of RACH configurations is received via a system information or radio resource control message.

Aspect 20: The method of any of Aspects 12-19, wherein the information identifying the set of RACH configurations includes one or more bitmaps indicating one or more synchronization signal block (SSB) directions to which one or more user-specific RACH occasions are applicable.

Aspect 21: The method of any of Aspects 12-20, further comprising: transmitting a system information message including a bitmap identifying a change to a set of beams with an active RACH configuration associated with the set of RACH configurations, and wherein receiving the RACH message in accordance with the set of RACH configurations comprises: receiving the RACH message in accordance with the bitmap.

Aspect 22: The method of Aspect 21, further comprising: receiving a request for a change to a set of UE-specific RACH occasions; and wherein transmitting the system information message comprises: transmitting the system information message as a response to receiving the request for the change.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive information identifying a set of random access channel (RACH) configurations, wherein a RACH configuration, of the set of RACH configurations, is at least one of: specific to the UE and applicable to a subset of beam directions of a set of beam directions, or specific to a beam; and
transmit a RACH message in accordance with the RACH configuration.

2. The UE of claim 1, wherein the RACH configuration includes a beam-specific timing advance offset for the RACH message.

3. The UE of claim 1, wherein the set of RACH configurations includes information identifying a plurality of timing advance offsets configured for a set of beams.

4. The UE of claim 3, wherein the RACH message is transmitted with a timing advance offset, of the plurality of timing advance offsets, in connection with a parameter, wherein the parameter is at least one of:
a type of the UE,
a distance metric associated with the UE,
a channel metric associated with the UE,
a received indication,
a coverage zone parameter,
a result of executing a machine learning model,
a synchronization signal block source, or
a result of executing a sensing procedure.

5. The UE of claim 1, wherein the one or more processors, to receive the information identifying the set of RACH configurations, are configured to:
receive the information identifying the set of RACH configurations based at least in part on backhaul signaling associated with establishing the set of RACH configurations.

6. The UE of claim 1, wherein the set of RACH configurations is received via a broadcast signal or a dedicated signal.

7. The UE of claim 1, wherein the one or more processors are further configured to:
transmit an indication of one or more RACH configurations; and
wherein the one or more processors, to receive the information identifying the set of RACH configurations, are configured to:
receive the information identifying the set of RACH configurations as a response to transmitting the indication of the one or more RACH configurations.

8. The UE of claim 1, wherein the information identifying the set of RACH configurations is received via a system information or radio resource control message.

9. The UE of claim 1, wherein the information identifying the set of RACH configurations includes one or more bitmaps indicating one or more synchronization signal block (SSB) directions to which one or more user-specific RACH occasions are applicable.

10. The UE of claim 1, wherein the one or more processors are further configured to:
receive a system information message including a bitmap identifying a change to a set of beams with an active RACH configuration associated with the set of RACH configurations, and wherein the one or more processors, to transmit the RACH message in accordance with the set of RACH configurations, are configured to:
transmit the RACH message in accordance with the bitmap.

11. The UE of claim 10, wherein the one or more processors are further configured to:
transmit a request for a change to a set of UE-specific RACH occasions; and
wherein the one or more processors, to receive the system information message, are configured to:
receive the system information message as a response to transmitting the request for the change.

12. A network node for wireless communication, comprising:
one or more memories; and
one or more processors coupled to the one or more memories, the one or more processors individually or collectively configured to:
transmit, to a user equipment (UE), information identifying a set of random access channel (RACH) configurations, wherein a RACH configuration, of the set of RACH configurations, is at least one of: specific to the UE and applicable to a subset of beam directions of a set of beam directions, or specific to a beam; and
receive a RACH message in accordance with the RACH configuration.

13. The network node of claim 12, wherein the RACH configuration includes a beam-specific timing advance offset for the RACH message.

14. The network node of claim 12, wherein the set of RACH configurations includes information identifying a plurality of timing advance offsets configured for a set of beams.

15. The network node of claim 14, wherein the RACH message is transmitted with a timing advance offset, of the plurality of timing advance offsets, in connection with a parameter, wherein the parameter is at least one of:
a type of the UE,
a distance metric associated with the UE,
a channel metric associated with the UE,
a received indication,
a coverage zone parameter,
a result of executing a machine learning model,
a synchronization signal block source, or
a result of executing a sensing procedure.

16. The network node of claim 12, wherein the one or more processors, to transmit the information identifying the set of RACH configurations, are configured to:
transmit the information identifying the set of RACH configurations based at least in part on backhaul signaling associated with establishing the set of RACH configurations.

17. The network node of claim 12, wherein the set of RACH configurations is received via a broadcast signal or a dedicated signal.

18. The network node of claim 12, wherein the one or more processors are further configured to:
receive an indication of one or more RACH configurations; and
wherein the one or more processors, to transmit the information identifying the set of RACH configurations, are configured to:
transmit the information identifying the set of RACH configurations as a response to receiving the indication of the one or more RACH configurations.

19. The network node of claim 12, wherein the information identifying the set of RACH configurations is received via a system information or radio resource control message.

20. The network node of claim 12, wherein the information identifying the set of RACH configurations includes one or more bitmaps indicating one or more synchronization signal block (SSB) directions to which one or more user-specific RACH occasions are applicable.

21. The network node of claim 12, wherein the one or more processors are further configured to:
transmit a system information message including a bitmap identifying a change to a set of beams with an active RACH configuration associated with the set of RACH configurations, and
wherein the one or more processors, to receive the RACH message in accordance with the set of RACH configurations, are configured to:
receive the RACH message in accordance with the bitmap.

22. The network node of claim 21, wherein the one or more processors are further configured to:
receive a request for a change to a set of UE-specific RACH occasions; and
wherein the one or more processors, to transmit the system information message, are configured to:
transmit the system information message as a response to receiving the request for the change.

23. A method of wireless communication performed by a user equipment (UE), comprising:
receiving information identifying a set of random access channel (RACH) configurations, wherein a RACH configuration, of the set of RACH configurations, is at least one of: specific to the UE and applicable to a subset of beam directions of a set of beam directions, or specific to a beam; and
transmitting a RACH message in accordance with the RACH configuration.

24. The method of claim 23, wherein the RACH configuration includes a beam-specific timing advance offset for the RACH message.

25. The method of claim 23, wherein the set of RACH configurations includes information identifying a plurality of timing advance offsets configured for a set of beams.

26. The method of claim 25, wherein the RACH message is transmitted with a timing advance offset, of the plurality of timing advance offsets, in connection with a parameter, wherein the parameter is at least one of:
a type of the UE,
a distance metric associated with the UE,
a channel metric associated with the UE,
a received indication,
a coverage zone parameter,
a result of executing a machine learning model,
a synchronization signal block source, or
a result of executing a sensing procedure.

27. The method of claim 23, wherein receiving the information identifying the set of RACH configurations comprises:
receiving the information identifying the set of RACH configurations based at least in part on backhaul signaling associated with establishing the set of RACH configurations.

28. The method of claim 23, wherein the set of RACH configurations is received via a broadcast signal or a dedicated signal.

29. A method of wireless communication performed by a network node, comprising:
transmitting, to a user equipment (UE), information identifying a set of random access channel (RACH) configurations, wherein a RACH configuration, of the set of RACH configurations, is at least one of: specific to the UE and applicable to a subset of beam directions of a set of beam directions, or specific to a beam; and
receiving a RACH message in accordance with the RACH configuration.

30. The method of claim 29, wherein the RACH configuration includes a beam-specific timing advance offset for the RACH message.
